(19) United States
(12) Patent Application Publication
(10) Pub. No.: US 2007/0064594 A1
(43) Pub. Date: Mar. 22, 2007

(54) Providing multiple communication protocol failover and remote diagnostics via a customer premise apparatus

(75) Inventor: T. ReNae Norton, Kennesaw, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/228,974

(22) Filed: Sep. 16, 2005

(51) Int. Cl. H04J 3/14

(52) U.S. Cl. 370/218; 370/228

(57) ABSTRACT

Computer-implemented methods, computer program products and customer premise equipment (CPE) apparatuses provide multiple communications protocol failover and remote diagnostic functionality in facilitating communication services to and from a user's premise. A method involves configuring a CPE apparatus for a primary data path and a secondary data path, receiving communications traffic via the CPE apparatus, aggregating the communications traffic, and routing the communications traffic via the primary data path. The method also involves determining whether the primary data path is active and in response to determining that the primary data path is inactive, failing over the communications traffic from the primary data path to the secondary data path thereby allowing redundancy via the CPE apparatus.

### TECHNICAL FIELD

The present invention is related to providing redundancy and remote diagnosis for problems in transmitting communications traffic. More particularly, the present invention is related to computer-implemented methods, apparatuses, and computer program products for providing multiple protocol failover and remote diagnostics.

### BACKGROUND

Communications service providers offer various services to customers including voice, data, and network services. Customer premise equipment (CPE) or hardware is frequently required to enable customers to utilize the provided service. For instance integrated voice and data services may be provided via a T1 service that requires an integrated access device (IAD) to interconnect the customer telephones and computing devices to the service provider's network.

When a customer experiences trouble with communications services, the customer may attempt to solve the problem herself. Subsequently, the customer may contact a customer service representative a network operations center (NOC) of the provider for assistance. When problems with installation and/or troubleshooting are complicated and not evident to the customer or the NOC, a technician may be dispatched to the customer's location. Some technicians must purchase an analog modem in order to download software to the customer's equipment for repair. This activity is often at the expense of the service provider. Also the business customer loses productivity due to loss of service. Even when an installed modem allows the NOC to access the customer site, customer service is still limited in the diagnostic information that can be retrieved due to a lack of integrated communication between network components.

Some conventional systems practice redundancy and have failover capability. However, these systems require the purchase of additional non-integrated equipment or the maintenance of two systems along with associated costs. These conventional systems do not provide extensive diagnostic information. Nor do the conventional systems resolve the cause of the problem and reestablish the primary data path after problem resolution.

Accordingly there is an unaddressed need in the industry to address the aforementioned and other deficiencies and inadequacies.

### SUMMARY

This Summary is provided to introduce a selection of concepts in simplified form that are further described below in the Detailed Description. This Summary is not intended to identify key features or essential features of the claimed subject matter, nor is the Summary intended for use as an aid in determining the scope of the claimed subject matter.

In accordance with embodiments of the present invention, methods, apparatuses, and computer program products provide multiple communications protocol failover and remote diagnostics to address the above and other problems. Embodiments of the present invention provide and implement CPE/firmware that combines the functionality of an IAD, a digital subscriber line (DSL) router, and an analog modem. Embodiments of the present invention are also IP Multimedia Service (IMS) compatible to further support voice over network (VON) architecture. Thus, embodiments of the present invention help reduce and/or streamline network management and network costs with scalable solutions.

One embodiment provides a computer-implemented method for providing multiple communications protocol failover and remote diagnostic functionality in facilitating communication services to and from a user's premise. The method involves configuring a CPE apparatus for a primary data path and a secondary data path, receiving communications traffic at the CPE apparatus, aggregating the communications traffic, and routing the communications traffic via the primary data path. The method also involves determining whether the primary data path is active and in response to determining that the primary data path is inactive, failing over the communications traffic from the primary data path to the secondary data path thereby allowing redundancy via the CPE apparatus.

Another embodiment is a computing apparatus for facilitating multiple protocol failover and remote diagnostic functionality for integrated communications services. The apparatus includes an integrated access device (IAD) operative to configure, install, and provision integrated voice and data services and an analog modem in communication with the IAD and operative to convert digital signals to modulated analog signals for transmission over a communications path and to transform incoming analog signals to a digital equivalent. The apparatus also includes a router in communication with the IAD and the analog modem. The router is operative to examine each data packet received to determine what path to send the data packet and send the data packet to a destination.

Additionally, the apparatus is compatible with time division multiplexing, voice over network, and/or IP multimedia service. The apparatus is operative to determine whether a primary data path is inactive, failover one or more of the communications services from the primary data path to a secondary data path, and facilitate remote diagnostic functionality to determine a cause of failing over. Still further, another embodiment is a computer program product comprising a computer-readable medium having control logic stored therein for causing a customer premise computing apparatus to provide multiple communications protocol failover and remote diagnostic functionality when a communication service data path becomes inactive. The control logic includes computer-readable program code for causing the computing apparatus to configure a primary data path and a secondary data path for communications traffic, receive the communications traffic over a service provider network, aggregate the communications traffic, and route the communications traffic via the primary data path. The control logic also includes computer-readable program code for causing the computing apparatus to determine whether the primary data path is active and in response to determining that the primary data path is inactive, fail over the communications traffic from the primary data path to the secondary data path, thus, allowing redundancy via the computing apparatus.

Aspects of the invention may be implemented as a computer process, a computing system, or as an article of manufacture such as a computer program product or computer-readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process.

Other apparatuses, computer program products, methods, features, systems, and advantages of the present invention will be or become apparent to one with skill in the art upon examination of the following drawings and detailed description. It is intended that all such additional apparatuses, methods, systems, features, and advantages be included within this description, be within the scope of the present invention, and be protected by the accompanying claims.

### BRIEF DESCRIPTION OF THE DRAWINGS

FIG. 1 is a schematic diagram illustrating aspects of a CPE apparatus and a communications networked environment utilized in an illustrative embodiment of the invention;

FIG. 2 illustrates the CPE apparatus of FIG. 1 in communication with other communications components at the customer premise and in communication with network components at a central office (CO) according to an illustrative embodiment of the invention;

FIG. 3 illustrates computing system architecture for the CPE apparatus of FIG. 1 utilized in an illustrative embodiment of the invention;

FIG. 4 illustrates an operational flow performed in providing multiple protocol failover and remote diagnostic functionality according to an illustrative embodiment of the invention; and

FIG. 5 illustrates an operational flow performed in diagnosing and repairing a failover cause according to an illustrative embodiment of the invention.

### DETAILED DESCRIPTION

As described briefly above, embodiments of the present invention are directed to methods, apparatuses, and computer-readable mediums for providing multiple protocol failover and remote diagnostic functionality. In the following detailed description, references are made to accompanying drawings that form a part hereof, and in which are shown by way of illustration specific embodiments or examples. These illustrative embodiments may be combined, other embodiments may be utilized, and structural changes may be made without departing from the spirit and scope of the present invention. The following detailed description is, therefore, not to be taken in a limiting sense, and the scope of the present invention is defined by the appended claims and their equivalents.

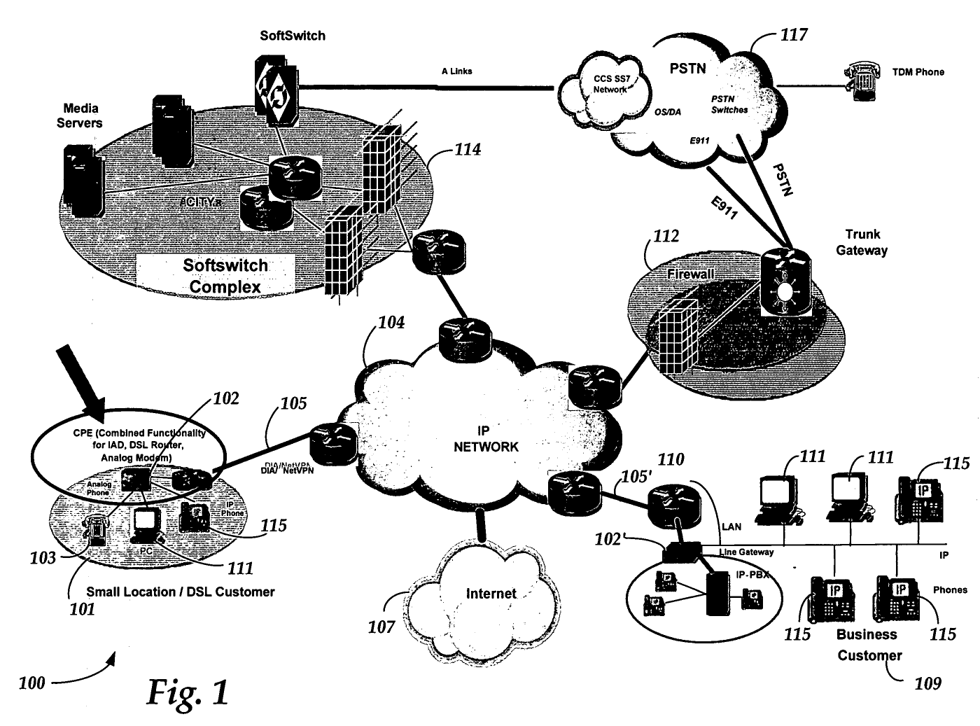

Referring now to the drawings, in which like numerals represent like elements through the several figures, aspects of the present invention and the illustrative operating environment will be described. FIGS. 1-3 and the following discussion are intended to provide a brief, general description of a suitable computing and communications network environment in which the embodiments of the invention may be implemented. While the invention will be described in the general context of program modules that execute in conjunction with firmware that executes on a computing apparatus, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 1, a schematic diagram illustrating aspects of a CPE apparatus 102 and a communications networked environment 100 utilized in an illustrative embodiment of the invention will be described. As shown in FIG. 1, the networked environment 100 includes a small DSL customer 101. The DSL customer 101 has an analog phone 103, a personal computer (PC) 111, and an IP phone 115 in communication with the CPE apparatus 102 that communicates with a service provider over a shared access link 105. It should be appreciated that the CPE apparatus 102 can be integrated with the phone 103, the PC 111, and/or the IP phone 115. The shared access link 105 may be a dedicated Internet access (DIA), net virtual private network (VPN), or any other data medium.

The networked environment 100 also includes a business customer 109. The business customer 109 has multiple PCs 111 and IP phones 115 in communication with a CPE apparatus 102′ via a LAN gateway 110. The CPE apparatus 102′ communicates with the service provider network via a shared access link 105′. The shared access links 105 and 105′ feed into an IP network 104, for example a regional backbone IP network (BRIB). The IP network 104 in turn provides access to the Internet 107, a soft switch complex 114 housing media and application servers, and a PSTN 117 via a firewall 112.

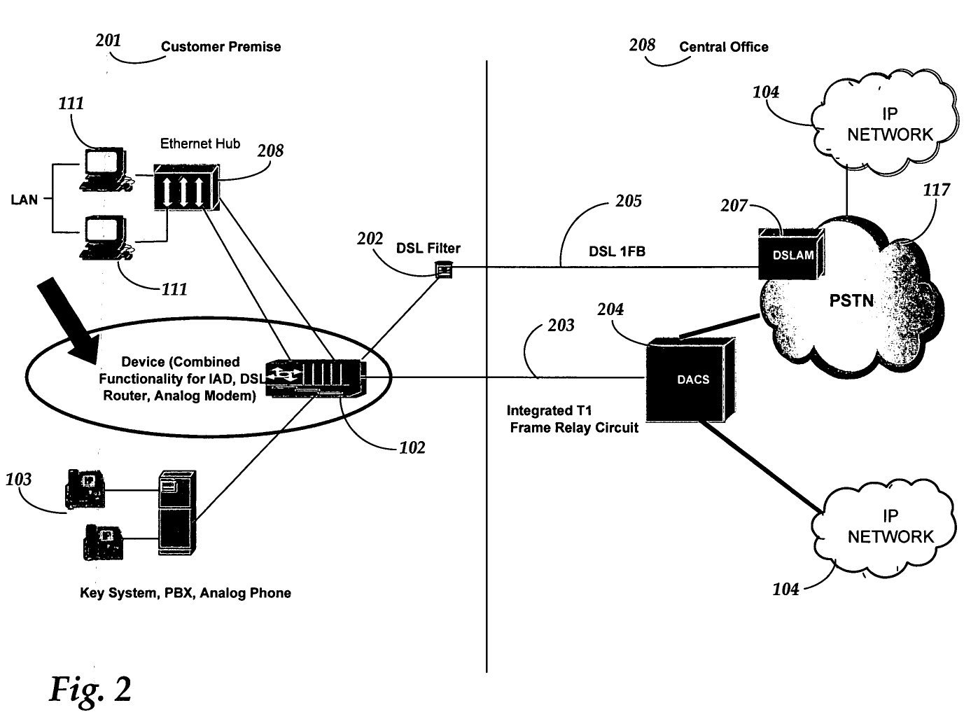

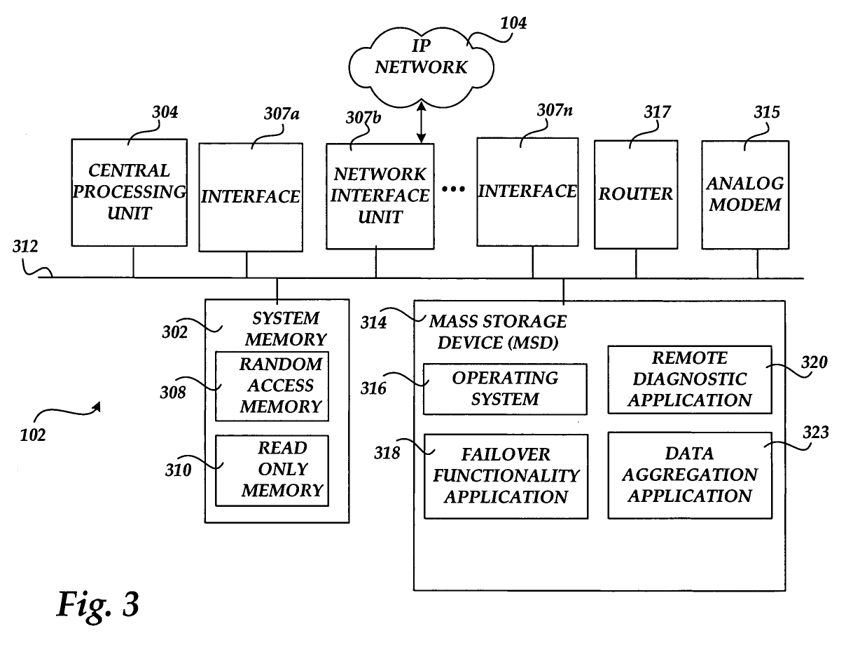

The CPE apparatus 102 integrates an IAD, for example with a capacity of T1×4, a DSL Router, for example supporting 6 megabytes of bandwidth up and down stream, and an analog modem. Combining the functionality of these devices provides failover and/or overload functionality in the event of an outage of a Private Virtual Circuit (PVC) or overload of data capacity. Combining the functionality also provides remote access for diagnostic testing. The CPE apparatus 102 supports any combination of TDM data circuits such as Frame Relay, DSL, and/or a VON data solution as a primary data path. Thus, allowing one or more other circuits to be a failover path, or secondary data path. The CPE apparatus 102 automatically defaults the communications or data traffic to the secondary data path in the event of an outage and will automatically revert the data traffic back to the primary data path when the outage is corrected. It should be appreciated that the CPE apparatus may also utilize the secondary path in conjunction with the primary path in the case of data path overloads. The TDM and/or VON network “mix-and-match” of the primary and secondary data paths provide a unique failover solution. Thus, via one apparatus, redundancy between traditional TDM network solutions and/or VON network solutions is allowed. Additional details regarding the CPE apparatus 102 will be described below with respect to FIGS. 2-3.

FIG. 2 illustrates the CPE apparatus 102 of FIG. 1 in communication with other communications components at the customer premise and in communication with network components at a central office (CO) according to an illustrative embodiment of the invention. The CPE apparatus 102 resides at customer premise 201 and is in direct communication with an Ethernet hub 208 that transmits data traffic to and from the PCs 111. The CPE apparatus 102 may be configured for a default or primary data path 203, illustrated as integrated T1, and a secondary data path 205, illustrated as DSL via a DSL filter 202. It should be appreciated that a tertiary data path or more data paths may also be configured.

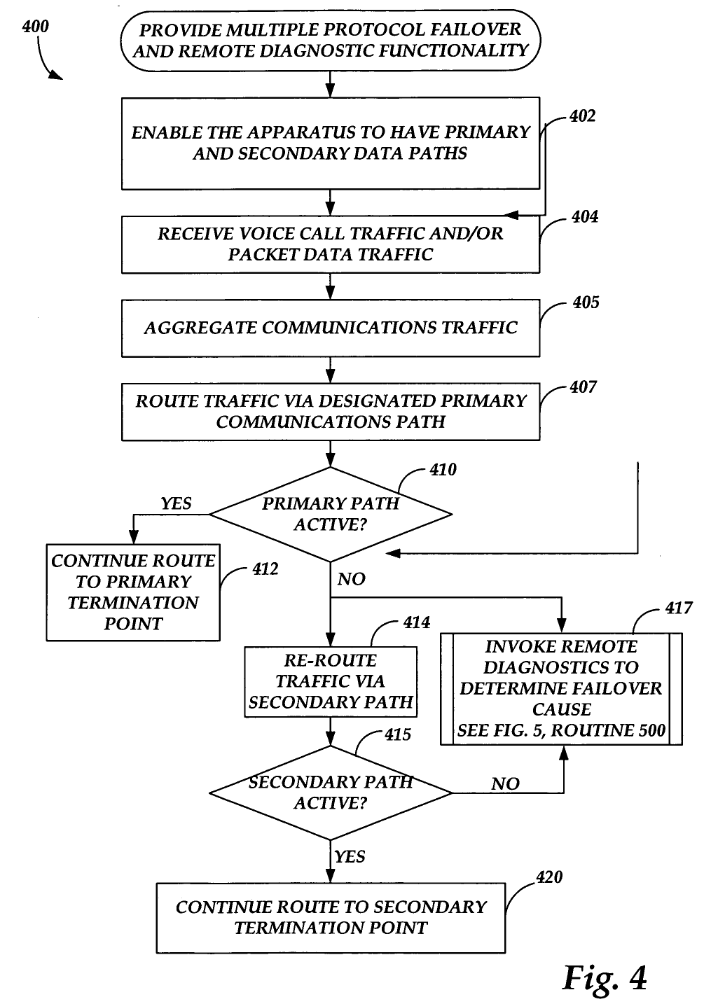

A primary data path termination point 204 illustrated as a digital access cross connect system (DACS), a digital switching device for routing Tls, receives communication traffic sent via the primary data path 203. Similarly, a secondary data path termination point 207, illustrated as a DSL multiplexer (DSLAM), receives communications traffic sent via the secondary data path 205. It should be appreciated that the CPE apparatus 102 supports traditional network platforms and VON platforms. Thus, customers benefit from continued use of their CPE apparatus 102 following migration from a TDM network supported solution to a VON network supported solution. It also should be appreciated that in a VON environment both voice and data traffic are provided over the same pipe or data path. Additional details regarding data paths will be described below with respect to FIG. 4.

Referring now to FIGS. 1-3, computing system architecture for the CPE apparatus 102 of FIG. 1, utilized in an illustrative embodiment of the invention, will be described. The CPE apparatus 102 handles all configuration, installation, and automatic provisioning of bundled communications services, for example voice and data. The CPE apparatus 102 consolidates the functionality of a channel bank for integrating voice connections, an IP router 317 for transporting data, a Dynamic Host Configuration Protocol (DHCP) server for IP address management, and an analog modem 315 for downloading software and remote diagnostics.

The CPE apparatus 102 includes an interface 307a for communicating with the personal computer 111 or the Ethernet hub 208. This interface 307a shares information with other components of the CPE apparatus 102 through a bus 312. The CPE apparatus 102 may also include other interfaces 307b-307n. Interface 307b, for instance, connects the CPE apparatus 102 to the physical connection of the IP network 104. The interfaces 307b-307n can also connect the CPE apparatus 102 to a telephone network 117 leading to a data network or to a cable connection of a TV network leading to a data network.

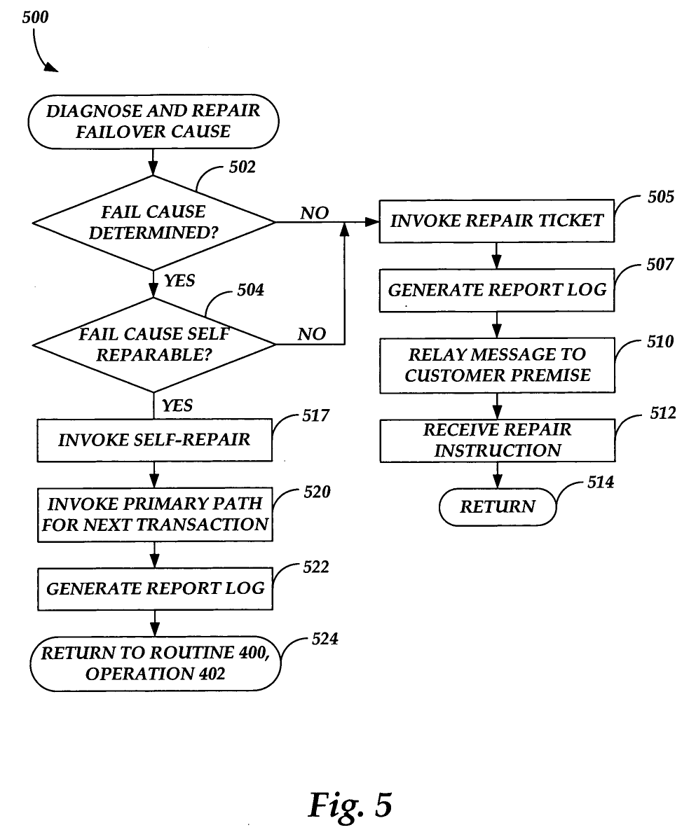

The CPE apparatus 102 also includes on-board processing, in addition to any processing that occurs for the transfer of data between interface 307a and interface 307b. The on-board processing is provided through a central processing unit (CPU) 304, an application specific integrated circuit, or other similar processing device type. The CPU 304 executes a remote diagnostic program (RDA) 320 to analyze specific information about the CPE apparatus 102 and its connections at the interfaces 307a-307n. The diagnostic program 320 is stored in on a mass storage device 314. The details of one example of the diagnostic program 320 and its interaction with one or more remote troubleshooting programs are discussed below with reference to FIG. 5. The RDA 320 may communicate with a troubleshooting application through a defined protocol. One example is that the RDA 320 may post test results to an extensible mark-up language (“XML”) document stored in memory that is accessible by the troubleshooting program. Additional details regarding the interaction between diagnostic programs and remote troubleshooting programs are found in U. S. Pat. application Ser. No. 10/603,949 entitled Methods and Devices For Communications Device Troubleshooting filed on Jun. 25, 2004 which is hereby incorporated in its entirety by reference.

The CPE apparatus 102 also includes a system memory 302 coupled to the CPU 304 via the system bus 312. The system memory 302 includes read-only memory (ROM) 310 and random access memory (RAM) 308. The MSD 314 also stores an operating system 316, a Failover Functionality application (FFA) 318 for providing failover for troubled data paths, and a data aggregation application (DAA) 323 for sending and receiving data associated with bundled communications services.

It should be appreciated that the MSD 314 may be a redundant array of inexpensive discs (RAID) system for storing data. The MSD 314 is connected to the CPU 304 through a mass storage controller (not shown) connected to the system bus 312. The MSD 314 and its associated computer-readable media, provide non-volatile storage for the CPE apparatus 102. Although the description of computer-readable media contained herein refers to a mass storage device, such as a hard disk or RAID array, it should be appreciated by those skilled in the art that computer-readable media can be any available media that can be accessed by the CPU 304.

The CPU 304 may employ various operations, discussed in more detail below with reference to FIGS. 4-5 to provide and utilize the signals propagated between the CPE apparatus 102 and other network components. The CPU 304 may store data to and access data from MSD 314. Data is transferred to and received from the storage device 314 through the system bus 312. The CPU 304 may be a general-purpose computer processor. Furthermore as mentioned below, the CPU 304, in addition to being a general-purpose programmable processor, may be firmware, hard-wired logic, analog circuitry, other special purpose circuitry, or any combination thereof.

According to various embodiments of the invention, the CPE apparatus 102 operates in a networked environment, as shown in FIG. 1, using logical connections to remote computing devices via network communication, such as an Intranet, or a local area network (LAN). The CPE apparatus 102 may connect to the network 104 via the network interface unit 307b. It should be appreciated that the network interface unit 307b may also be utilized to connect to other types of networks and remote computer systems.

A computing system, such as the CPE apparatus 102, typically includes at least some form of computer-readable media. Computer readable media can be any available media that can be accessed by the CPE apparatus 102. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the CPE apparatus 102.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

All the voice and data traffic feed into the CPE apparatus 102. For instance, a full T1 data path can provide at least 24 channels with some allocated to data and others to voice. When a data path fails, the FFA 318 fails the communications traffic over to another communications protocol. For instance, the FFA 318 can failover between VON and DSL. Other options may include DIA to DSL, DSL to VPN, VON to integrated T1, or any other data medium combinations. Thus, the CPE apparatus 102 allows customers to operate in a hybrid environment and mix and match their equipment. For example, when a customer moves from TDM to VON, the same CPE apparatus 102 will suffice. Similarly, if a VON network goes down, the CPE apparatus 102 can failover to a DSL environment. Additional details regarding the FFA 318 will be described below with respect to FIG. 4.

FIG. 4 illustrates an operational flow 400 performed in providing multiple protocol failover and remote diagnostic functionality according to an illustrative embodiment of the invention. The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system or apparatus implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

Referring now to FIGS. 1-4, the operational flow begins at operation 402 where the FFA 318 configures or enables the CPE apparatus or device 102 to have a primary communications path, for example, T1 203, and a secondary communications path, for example, DSL. It should also be appreciated that the FFA 318 may also configure the CPE apparatus 102 for a tertiary or even more data paths.

Next the operational flow 400 continues at operation 404 where the CPE apparatus 102 sends and/or receives communications traffic, such as voice call and/or data packet traffic over the provider network 104. Then at operation 405, the CPE apparatus 102 aggregates the communications traffic and continues to operation 407.

At operation 407 the CPE apparatus 102 routes the traffic via the data path configured or designated as the primary or default data path. Next at operation 410, the FFA 318 determines whether the primary data path is active. When the primary data path is active, the operation flow 400 continues from operation 410 to operation 412 where the CPE apparatus 102 continues to route the communications traffic to a primary termination point, such as the DACS termination point 204. Then operational flow 400 returns from operation 412 to operation 410 described above.

When at operation 410, the FFA 318 determines that the primary data path is inactive, the operational flow 400 continues from operation 410 to operations 414 and 417 described below.

At operation 414, the FFA 318 fails over or re-routes the communications traffic via the secondary data path. The CPE apparatus 102 is compatible with Internet Protocol multimedia service (IMS), TDM, and/or VON. Thus, failing over the communications traffic from a primary data path to a secondary data path may include re-routing traffic from a (DSL) data path to a T1 data path, from a T1 data path to a DSL data path, from a VON data path to a T1 data path, and/or from a DSL data path to VON data path and visa versa. Failing over may also include re-routing traffic from a VON data path to a DSL data path, from a DIA data path to a VPN data path, and/or from a VPN data path to a DIA data path as well as other data path medium combinations.

Then at operation 415, the FFA 318 determines whether the secondary data path is active. When at operation 415, the secondary data path is determined to be active, the operational flow 400 continues to operation 420. At operation 420, the CPE apparatus 102 continues to route the communications traffic to a secondary termination point, such as the DSLAM termination point 207. The operational flow 400 then continues from operation 420 to operation 415 described above. When at operation 415, the FFA 318 determines that the secondary data path is inactive, the operational flow 400 continues from operation 415 to operation 417 described below.

At operation 417, the FFA 318 invokes the RDA application 320 to determine causes of the one or more failovers. Additional details regarding remotely diagnosing and repairing one or more causes of failovers will be described below with respect to FIG. 5.

FIG. 5 illustrates an operational flow 500 performed by the RDA 320 in diagnosing and repairing a failover cause according to an illustrative embodiment of the invention. The operational flow 500 begins at operation 502 where the RDA 320 determines whether a cause of the failure has been determined. When a cause has not been determined the operational flow 500 continues to operation 505 described below. When a cause of a failover has been determined the operational flow 500 continues from operation 502 to operation 504.

At operation 504 the RDA 320 determines whether the cause is self-reparable. When the cause is determined to be self-reparable, the operational flow 500 continues from operation 504 to operation 517 described below. When at operation 504, the RDA 320 determines that the cause of the failover is not self-repairable, the operational flow 500 continues from operation 504 to operation 505.

At operation 505, the RDA 320 invokes a repair or trouble ticket. By invoking a trouble ticket, the RDA 320 issues a message to customer service of the service provider providing details of the problem as determined by the RDA 320. Then at operation 507, the RDA 320 generates a report log. Next at operation 510, the RDA 320 relays a message to the customer. This message can be relayed via electronic mail or a graphical user interface (GUI). The message may include a status message regarding the resolution of the cause of the problem.

Then at operation 512, the CPE apparatus 102 receives repair instructions, for example, remotely from a NOC working on the problem. The operational flow 500 then returns control to other routines at return operation 514.Referring again to operation 504, when the cause of the failover is self-repairable, the RDA 320 invokes a self-repair at operation 517. Thus, the cause is repaired, for example, via reboot attempts. Next at operation 520, the RDA 320 invokes the primary path for subsequent communications traffic. Then at operation 522, the RDA 320 generates a report log. Next at return operation 524, control is returned to operation 402 described above with respect to FIG. 4.

Thus, by having the troubleshooting interactive, the customer experiences self-repair or receives pertinent messages via email or another interface. Calls to customer service are reduced because of real time feedback based on enhanced diagnostic capabilities of the RDA 320.

Thus, the present invention is presently embodied as methods, systems, apparatuses, computer program products or computer readable mediums encoding computer programs for providing multiple communications protocol failover and remote diagnostic functionality via a customer premise equipment (CPE) apparatus utilized in providing communication services.

The above specification, examples and data provide a complete description of the manufacture and use of the composition of the invention. Since many embodiments of the invention can be made without departing from the spirit and scope of the invention, the invention resides in the claims hereinafter appended.

We Claim:

1. A computer-implemented method for providing multiple communications protocol failover and remote diagnostic functionality via a customer premise equipment (CPE) device, the method comprising:
enabling the CPE device to have a primary data path and a secondary data path;
routing communications traffic via the primary data path;
determining whether the primary data path is active; and
in response to determining that the primary data path is inactive, failing over the communications traffic from the primary data path to the secondary data path.

2. The method of claim 1, further comprising in response to determining that the primary data path is inactive, invoking remote diagnostic functionality to determine a cause of the primary data path becoming inactive.

3. The method of claim 2, wherein invoking the remote diagnostic functionality comprises:
detecting whether the cause of the primary data path becoming inactive has been determined;
in response to the cause being determined, detecting whether the cause is self reparable; and
in response to the cause being self reparable:
invoking a self repair of the cause;
invoking the primary data path for subsequent communications traffic; and
generating a report log.

4. The method of claim 3, further comprising in response to the cause not being determined or the cause not being self reparable:
invoking a repair ticket;
generating a report log; relaying a message to a user of the CPE device; and
receiving repair instructions.

5. The method of claim 1, further comprising:
determining whether the secondary data path is active;
in response to determining that the secondary path is inactive, invoking remote diagnostic functionality to determine a cause of the secondary data path becoming inactive; and
in response to determining that the secondary data path is active, continuing to route the communications traffic to a secondary termination point via the secondary path.

6. The method of claim 1, further comprising in response to determining that the primary data path is active, continuing to route the communications traffic to a primary termination point via the primary data path.

7. The method of claim 5, wherein the CPE device is compatible with at least one of Internet Protocol multimedia service (IMS), TDM, or VON and wherein failing over the communications traffic from the primary data path to the secondary data path comprises one of the following:
re-routing at least one of a voice call or data packet traffic from a digital subscriber line (DSL) data path to a T1 data path;
re-routing at least one of a voice call or data packet traffic from a T1 data path to a DSL data path;
re-routing at least one of a voice call or data packet traffic from a DSL data path to a voice over network (VON) data path;
re-routing at least one of a voice call or data packet traffic from a VON data path to a DSL data path;
re-routing at least one of a voice call or data packet traffic from a dedicated internet access (DIA) data path to a VPN data path; and re-routing at least one of a voice call or data packet traffic from a VPN data path to a DIA data path.

8. The method of claim 7, wherein continuing to route the communications traffic to a secondary termination point via the secondary path comprises routing at least one of a voice call or data packet traffic to one of a DSLAM termination point or a DACS termination point.

9. The method of claim 4, wherein invoking a repair ticket comprises issuing a troubleshooting and repair notice via the remote diagnostic functionality to the Internet.

10. The method of claim 4, wherein relaying a message comprises sending a text message to a customer via at least one of electronic mail or a graphical user interface.

11. The method of claim 1, further comprising:
enabling the CPE device for a tertiary data path; and
in response to determining that the primary data path is inactive, failing over the communications traffic from the primary data path to the tertiary data path and the secondary data path thereby allowing redundancy via the CPE device.

12. A computing apparatus for facilitating multiple protocol failover and remote diagnostic functionality for integrated communications services, the apparatus comprising:
an integrated access device (IAD) operative to configure, to install, and to provision integrated voice and data services, the IAD enabled to have a primary data path and a secondary data path;
an analog modem in associative communication with the IAD and operative to convert digital signals to analog signals and to transform incoming analog signals to a digital equivalent; and
a router in associative communication with the IAD and the analog modem, the router operative to determine what path to send each data packet received;
wherein the apparatus is compatible with at least one of time division multiplexing, voice over network, or IP multimedia service and wherein the apparatus is operative to:
determine whether the primary data path is inactive;
failover one or more of the communications services from the primary data path to at least the secondary data path in response to determining that the primary data path is inactive; and
facilitate remote diagnostic functionality to determine a cause of failing over.

13. The apparatus of claim 12, further operative to return the communications services to the first data path upon resolving the cause of failing over.

14. The apparatus of claim 12, further operative to determine whether the secondary data path is active and invoke the remote diagnostic functionality in response to determining that the secondary data path is inactive.

15. The apparatus of claim 12, wherein the apparatus operative to facilitate remote diagnostic functionality is operative to:
detect whether the cause of the primary data path becoming inactive has been determined;
in response to the cause being determined, detect whether the cause is self reparable; and
in response to the cause being self reparable:
invoke a self repair of the cause;
invoke the primary data path for subsequent communications traffic; and
generate a report log.

16. The apparatus of claim 15, wherein the apparatus operative to facilitate remote diagnostic functionality is operative in response to the cause not being determined or the cause not being self reparable to:
invoke a trouble ticket;
generate a report log;
relay a message to a user of the apparatus; and
receive repair instructions.

17. A computer program product comprising a computer-readable medium having control logic stored therein for causing a customer premise computing apparatus to provide multiple communications protocol failover and remote diagnostic functionality when a communication service data path becomes inactive, the control logic comprising computer-readable program code for causing the computing apparatus to:
enable a primary data path and a secondary data path for communications traffic;
receive the communications traffic;
aggregate the communications traffic;
route the communications traffic via the primary data path;
determine whether the primary data path is active; and
in response to determining that the primary data path is inactive, fail over the communications traffic from the primary data path to the secondary data path thereby allowing redundancy via the computing apparatus.

18. The computer program product of claim 17, further comprising computer-readable program code for causing the computing apparatus to invoke remote diagnostic functionality to determine a cause of the primary data path becoming inactive in response to determining that the primary data path is inactive.

19. The computer program product of claim 18, wherein the computer-readable program code for causing the computing apparatus to invoke remote diagnostic functionality comprises computer-readable program code for causing the computing apparatus to:
detect whether the cause of the primary data path becoming inactive has been determined;
in response to the cause being determined, detect whether the cause is self reparable;
in response to the cause being self reparable:
invoke a self repair of the cause;
invoke the primary data path for subsequent communications traffic; and
generate a report log; and
in response to the cause not being determined or the cause not being self reparable:
invoke a trouble ticket;
generate a report log;
relay a message to a user of a communications service; and
receive repair instructions.

20. The computer program product of claim 17, wherein the computing apparatus is compatible with at least one of Internet Protocol multimedia service (IMS), TDM, or VON and wherein the computer-readable program code for causing the computing apparatus to fail over the communications traffic from the primary data path to the secondary data path comprises one of the following:
computer-readable program code for causing the computing apparatus to re-route at least one of a voice call or data packet traffic from a digital subscriber line (DSL) data path to a T1 data path;
computer-readable program code for causing the computing apparatus to re-route at least one of a voice call or data packet traffic from a T1 data path to a DSL data path;
computer-readable program code for causing the computing apparatus to re-route at least one of a voice call or data packet traffic from a DSL data path to a voice over network (VON) data path;
computer-readable program code for causing the computing apparatus to re-route at least one of a voice call or data packet traffic from a VON data path to a DSL data path;
computer-readable program code for causing the computing apparatus to re-route at least one of a voice call or data packet traffic from a dedicated internet access (DIA) data path to a VPN data path; and
computer-readable program code for causing the computing apparatus to re-route at least one of a voice call or data packet traffic from a VPN data path to a DIA data path.

21. A computing apparatus for providing multiple protocol failover functionality for communications services, the apparatus comprising:
an integrated access device (LAD) operative to configure, to install, and to provision integrated voice and data services, the IAD enabled to have a T1 data path and a voice over network (VON) data path for communications traffic;
an analog modem in associative communication with the IAD and operative to convert digital signals to modulated analog signals for transmission over a communications path and to transform incoming analog signals to a digital equivalent; and
a router in associative communication with the IAD and the analog modem, the router operative to examine each data packet received to determine what path to send the data packet and to send the data packet to a destination;
wherein the apparatus is operative to:
route the communications traffic via the T1 data path;
determine whether the T1 data path is inactive; and
failover the communications traffic from the T1 data path to the VON data path in response to determining that the T1 data path is inactive.

22. The apparatus of claim 21, further comprising a phone in associative communication with the IAD, wherein the apparatus is further operative to generate the communications traffic.
